(19) United States
(12) Patent Application Publication
(10) Pub. No.: US 2008/0043273 A1
(43) Pub. Date: Feb. 21, 2008

(54) Target patterns providing quality assurance verification and security authentication

(76) Inventors: Steven J. Simske, Fort Collins, CO (US); Jason S. Aronoff, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/465,763

(22) Filed: Aug. 18, 2006

(51) Int. Cl. G06K 15/00

(52) U.S. Cl. 358/1.14

(57) ABSTRACT

Target patterns capable of being printed on a medium are determined. The target patterns are adapted to provide quality assurance (QA) verification of at least a reading device capable of reading the target patterns printed on the medium. The target patterns are also adapted to provide security authentication of an entity associated with printing of the target patterns on the medium. The target patterns are then printed on the medium.

### BACKGROUND

For target patterns, such as barcodes, modulation transfer function (MTF) patterns, and other types of indicia, to be printed on media, one consideration is to provide for quality assurance (QA) verification of different combinations of reading devices and printing devices. A given combination of a reading device and a printing device may, for instance, include an optical scanning device and a laser or ink-ejection printing device. Thus, for such a combination, it can be important that the scanning device is able to properly read the target patterns printed on media by the printing device.

Another consideration for target patterns printed on media is to provide for authentication of an entity associated with the printing of the target patterns on the media. For example, a company may package its products in boxes on which the target patterns are printed. To ensure that a given product in a box indeed originates from the company, and is not counterfeit, security authentication of the company's product may be performed based on authenticating whether the target patterns printed on the box were printed by or under the authority of the company in question.

### BRIEF DESCRIPTION OF THE DRAWINGS

FIG. 1 is a diagram of an exemplary sequence of modulation transfer function (MTF) target patterns, according to an embodiment of the invention.

FIGS. 2A and 2B are diagrams of exemplary capture profiles of the MTF target patterns of FIG. 1 by a representative reading device, according to an embodiment of the invention.

FIG. 3 is a flowchart of a method for generating and printing MTF target patterns for quality assurance verification purposes and security authentication purposes, according to an embodiment of the invention.

FIG. 4 is a diagram of an example number of sequences of MTF target patterns, according to an embodiment of the invention.

FIG. 5 is a diagram of a number of high frequency-low frequency MTF target pattern pairs, according to an embodiment of the invention.

FIG. 6 is a flowchart of a method for reading MTF target patterns, and performing quality assurance verification and/or security authentication, according to an embodiment of the invention.

FIG. 7 is a block diagram of a rudimentary system, according to an embodiment of the invention.

### DETAILED DESCRIPTION OF THE DRAWINGS

### Modulation Transfer Function (MTF) and MTF Target Patterns Generally

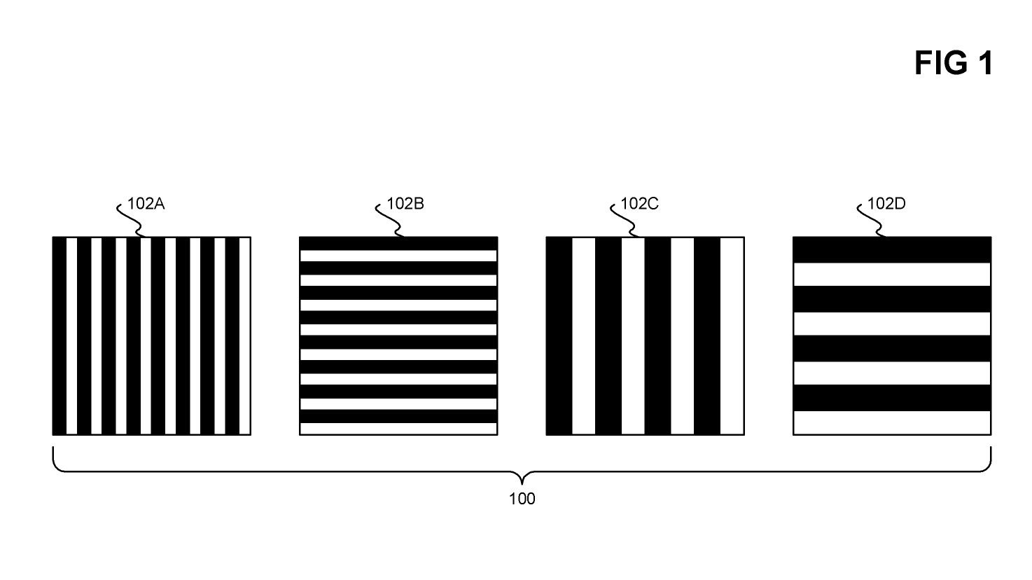

In this section of the detailed description, information regarding exemplary target patterns and an exemplary modulation transfer function (MTF) are provided. FIG. 1 shows an exemplary sequence 100 of MTF target patterns 102A, 102B, 102C, and 102D, collectively referred to as the MTF target patterns 102, according to an embodiment of the invention. Each of the MTF target patterns 102 is a series of black-and-white parallel straight lines, or bars. Within a given MTF target pattern, the black lines and the white lines have the same width.

The MTF target patterns 102A and 102B differ from the MTF target patterns 102C and 102D in that the former have a higher lines-per-inch frequency than the latter, such that the latter has wider lines than the former. The MTF target patterns 102A and 102B differ from one another in that the former has its lines running vertically, whereas the latter has its lines running horizontally. Likewise, the MTF target patterns 102C and 102D differ from one another in that the former has its lines running vertically, whereas the latter has its lines running horizontally. It is noted that while the high-frequency target patterns 102A and 102B are ordered before the low-frequency target patterns 102C and 102D, in another embodiment the order may be reversed. More generally, the order in which the target patterns 102 are printed is not limited by embodiments of the invention.

The MTF target patterns 102 may be defined by their lines being generated to have a mean thickness matching that predicted by the following lines-per-inch definition:

$$Line thickness = \frac{resolution}{2 \times lines per inch} . \qquad ( 1 )$$

In this definition, resolution is the dots-per-inch or pixels-per-inch resolution of the printing device printing the MTF target patterns 102. For example, a seventy lines-per-inch pattern generated at six-hundred dots per inch have lines with thickness of

$$\frac{600}{2 \times 70} ,$$

or 4.286 pixels. Because lines usually have to be defined in integer multiples of pixels, a cumulative residual may be tracked, and when the residual meets or exceeds one, an extra pixel added to the thickness of the next line.

The sequence 100 of the MTF target patterns 102 is for exemplary purposes only. In actuality, where series of black-and-white parallel straight lines are employed for an MTF target pattern, the lines-per-inch frequencies typically are measured in the tens to the hundreds. The lines of an MTF target pattern may alternatively be dark and light instead of black and white. The lines of an MTF target pattern may also alternatively be concentric annular lines, instead of parallel straight lines. A given MTF target pattern may measure less than one inch-by-one inch. Other embodiments of the invention are amenable to other modifications to the exemplary MTF target patterns 102 of FIG. 1.

The sequence 100 of the MTF target patterns 102 is employed to measure an MTF of the quality of a reading device, such as an optical scanning device or other capturing device, relative to the MTF target patterns 102 being printed on a printing medium by a printing device, such as a laser or ink-ejection printing device. In particular, the MTF measures a reading device's ability to discern high frequency black-to-white transitions. Generally, a number of sequences of MTF target patterns, such as the sequence 100 of the MTF target patterns 102, are employed to measure the quality of a reading device, where different sequences have different low-frequency MTF target patterns and different high-frequency target patterns. The correspondingly determined MTF values for the reading device in relation to these different sequences can then be compared against specified MTF values, to determine whether the reading device is able to properly distinguish between black and white within specifications.

The low-frequency MTF target patterns 102C and 102D may thus be of sufficiently low frequency that the reading device in question is able to detect completely true black points within the black lines, and able to detect completely true white points within the white lines. The high-frequency MTF target patterns 102A and 102B may thus be of sufficiently high frequency that the reading device in question is unable to detect true black points within the black lines, and is unable to detect true white points within the white lines. For a given combination of a particular reading device reading the MTF target patterns 102 and a particular printing device printing the MTF target patterns 102, these low and high frequencies can vary.

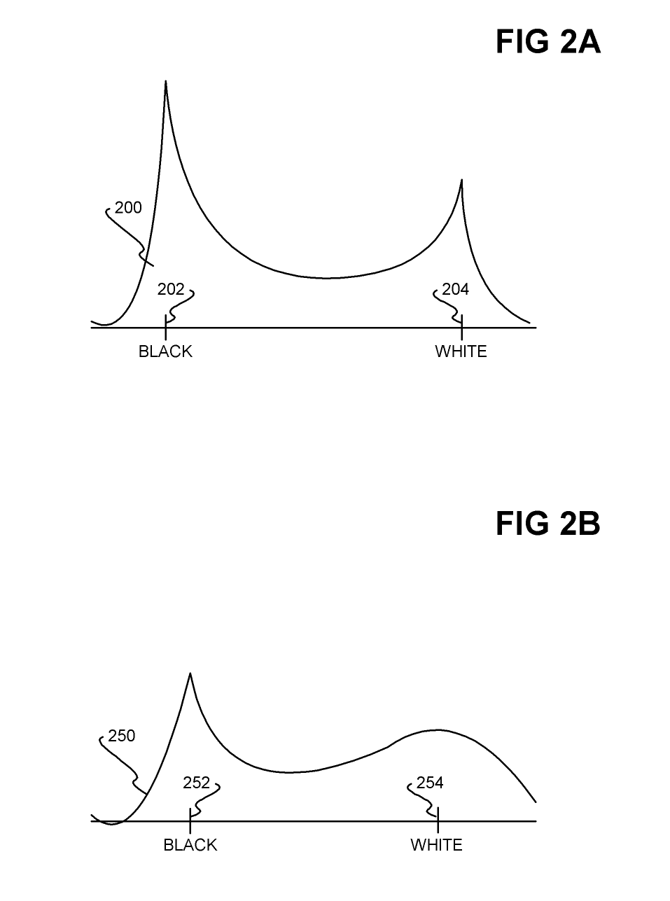

FIGS. 2A and 2B show exemplary capture profiles of the MTF target patterns 102 by a representative reading device, according to an embodiment of the invention. The profile 200 of FIG. 2A is for the low-frequency MTF target patterns 102C and 102D, whereas the profile 250 of FIG. 2B is for the high-frequency MTF target patterns 102A and 102B. In the profile 200, the two well-defined peaks at the black and white points 202 and 204 show that the reading device is able to well distinguish completely true black points and true white points within the low-frequency MTF target patterns 102C and 102D. In the profile 250, the peak at the black point 252 is well defined, but nevertheless shorter than the peak at the black point 202 of the profile 200, denoting that the reading device is having more trouble distinguishing true black points within the high-frequency MTF target patterns 102A and 102B. Furthermore, the peak at the white point 254 of the profile 250 is not well defined, indicating that the reading device is unable to distinguish well true white points within the high-frequency MTF target patterns 102A and 102B.

An exemplary MTF can itself be mathematically described by the following two equations:

$$\begin{matrix}{MTF}_{vertical} = \frac{{( {Val}_{white} - {Val}_{black} )}_{vertical}^{high}}{{( {Val}_{white} - {Val}_{black} )}_{vertical}^{low}} & ( 2 ) \\ {MTF}_{horizontal} = \frac{{( {Val}_{white} - {Val}_{black} )}_{horizontal}^{high}}{{( {Val}_{white} - {Val}_{black} )}_{horizontal}^{low}} & ( 3 )\end{matrix}$$

Equation (2) defines the MTF of a reading device in relation to the vertical MTF target patterns 102A and 102C, whereas equation (3) defines the MTF of the reading device in relation to the horizontal MTF target patterns 102B and 102D. Ideally, MTF_{vertical} is equal to MTF_{horizontal}, but many types of reading devices have one of these values different than the other.

Equation (2) determines a difference between a white detected value for the high-frequency vertical MTF target pattern 102A and a black detected value for this same pattern 102A, as well as a difference between a white detected value for the low-frequency vertical MTF target pattern 102C and a black detected value for this same pattern 102C. For instance, the black and white high-frequency values may be the values of the profile 250 at the points 252 and 254, respectively, whereas the black and white low-frequency values may be the values of the profile 200 at the points 202 and 204, respectively. The values may represent luminosity, or another physical characteristic measured by the reading device. The former difference is divided by the latter difference to arrive at the vertical MTF.

Likewise, equation (3) determines a difference between a white detected value for the high-frequency horizontal MTF target pattern 102B and a black detected value for this same pattern 102B, and a difference between a white detected value for the low-frequency MTF target pattern 102D and a black detected value for this same pattern 102D. For instance, the black and white high-frequency values may be the values of the profile 250 at the points 252 and 254, respectively, whereas the black and white low-frequency values may be the values of the profile 200 at the points 202 and 204, respectively. (It is noted that, in actuality, the horizontal values likely differ from the vertical values, such that the same profiles 200 and 250 do not show both the horizontal and vertical values.) The values may represent luminosity, intensity, or another spectral or physical characteristic measured by the reading device. The former difference is divided by the latter difference to arrive at the horizontal MTF.

The MTF and the MTF target patterns that have been described in this section of the detailed description are one type of MTF and one type of MTF target patterns. Other types of MTF's and other types of MTF target patterns also exist, as can be appreciated by those of ordinary skill within the art. Indeed, in at least some embodiments, other types of target patterns may be employed, other than MTF target patterns. Therefore, embodiments of the invention are not limited to the particular MTF and the particular MTF target patterns that have been presented in this section of the detailed description.

### Method for Printing MTF Target Patterns for Quality Assurance and Authentication

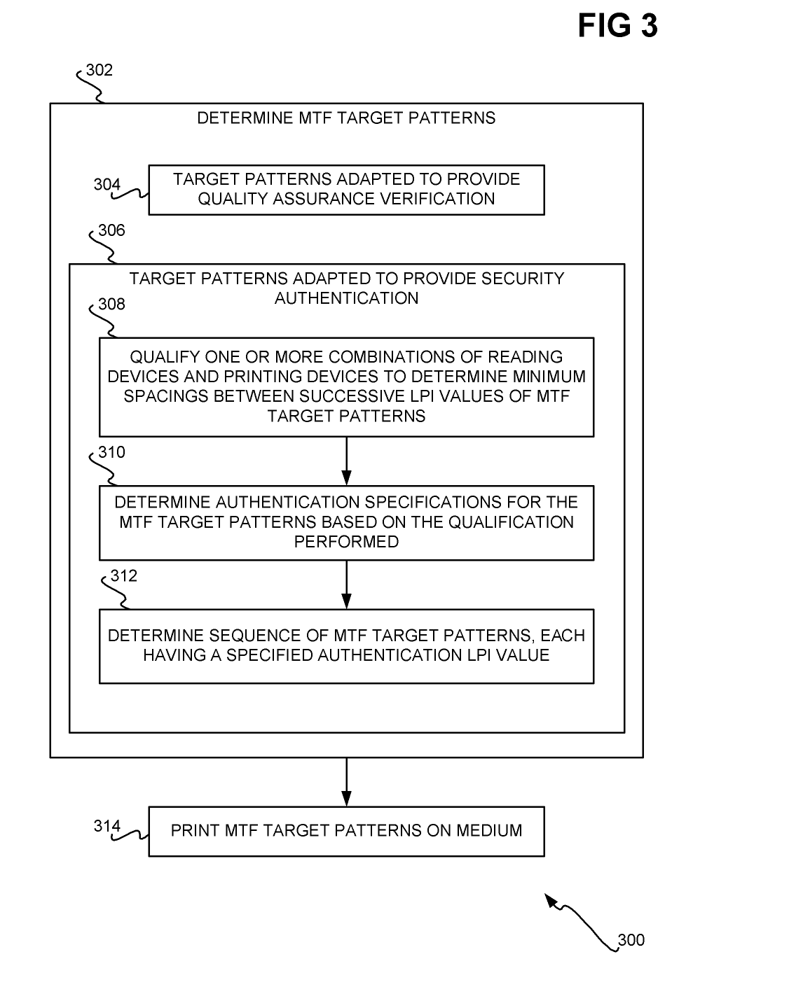

FIG. 3 shows a method 300 for generating and printing modulation transfer function (MTF) target patterns for both quality assurance verification purposes and security authentication purposes, according to an embodiment of the invention. The method 300 may be performed in one embodiment as one or more computer programs stored on a computer-readable medium, for execution on a computing device or another type of device having computing capability. The method 300 determines MTF target patterns that are to be printed on a medium (302). The MTF target patterns are particularly adapted to provide two different functions, or satisfy two different purposes.

First, the MTF target patterns are adapted to provide quality assurance verification of a reading device capable of reading the MTF target patterns printed on the medium (304). More specifically, the MTF target patterns are adapted to provide quality assurance verification of one or more combinations of such reading devices and printing devices that print the MTF target patterns on media. For example, there may be two different types of optical scanning devices that may potentially read the MTF target patterns printed on media, and there may be two different types of printing devices that may print the MTF target patterns on the media. Therefore, the MTF target patterns are adapted to provide quality assurance verification with respect to each of the two types of optical scanning devices reading the MTF target patterns printed on the media by each of the two types of printing devices, for a total of four different reading device-printing device combinations.

Quality assurance verification is the process of having a reading device, such as an optical scanning device, read a number of MTF target patterns, determine the resulting MTF values, and compare the MTF values against expected values or tolerances. If a reading device's MTF values for one or more of the MTF target pattern pairs is outside specification, then the reading device is considered to have failed quality assurance verification. Therefore, in part 302 a sufficiently large number of MTF target patterns is determined to ensure that any desired reading device or type of reading device can have its quality assurance verified upon reading the MTF target patterns, as can be appreciated by those of ordinary skill within the art.

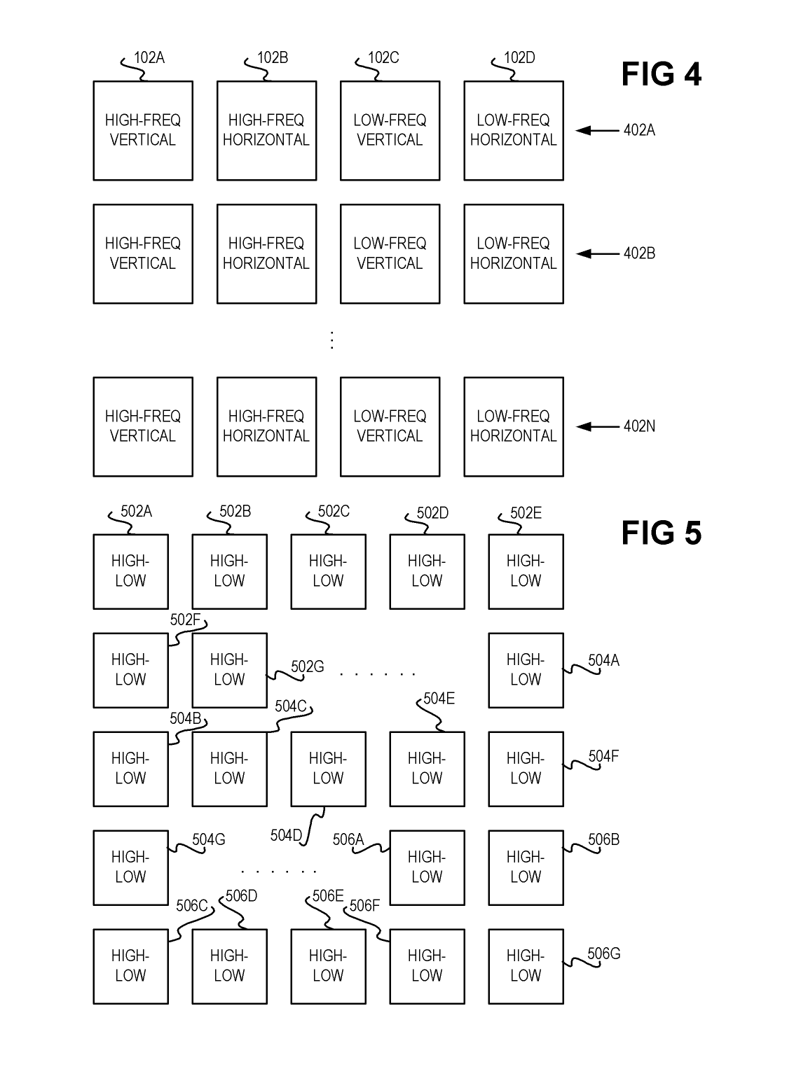

FIG. 4 shows an example of a number of sequences of MTF target patterns 402A, 402B, . . . , 402N, collectively referred to as the sequences 402, that may be determined to satisfy the constraint of part 304 of the method 300 of FIG. 3, according to an embodiment of the invention. Each of the sequences of MTF target patterns 402 includes a high-frequency vertical MTF target pattern, a high-frequency horizontal MTF target pattern, a low-frequency vertical MTF target pattern, and a low-frequency horizontal MTF target pattern. For example, the sequence 402A may include the MTF target patterns 102 of FIG. 1 that have been described. As such, the MTF target patterns 102A and 102B have a lines-per-inch (LPI) value that is greater than the LPI value of the MTF target patterns 102C and 102D. An MTF value for the sequence 402A is thus determinable based on these LPI values as read by the reading device in question.

The sequences of MTF target patterns 402 further have unique combinations of low frequencies and high frequencies. For example, the high frequency-low frequency pair of the sequence 402A differs from the high frequency-low frequency pair of the sequence 402B, which differs from the high frequency-low frequency pair of the sequence 402N, and so on. The number of the sequences 400 and the particular combinations of low frequencies to high frequencies of the MTF target patterns thereof are selected so that the quality assurance can be properly performed as to desired different combinations of reading devices and printing devices. Such selection may be achieved empirically, and/or based upon the reading characteristics of the reading devices and the printing characteristics of the printing devices, as can be appreciated by those of ordinary skill within the art.

Referring back to FIG. 3, the MTF target patterns are also adapted to provide security authentication of an entity associated with the printing of the MTF target patterns on the medium (306). A given pair of MTF target patterns having the LPI pair {low, high} can be considered a security code for these MTF target patterns. By specifying a number of such pairs of MTF target patterns, an effective security authentication mechanism can be provided. To determine whether the MTF target patterns printed on a medium indeed originated by or under the authority of a given entity, such as a company, a user simply has to read the appropriate MTF target patterns, and compare their read, or printed, LPI values with previously specified authentication LPI values. Where all these LPI values match, then authentication is considered successful. Alternatively, a user may read the appropriated MTF target patterns to discern their LPI values calculate or otherwise determine one or more MTF values based on these LPI values, and compare the MTF values with previously specified authentication MTF values. Where all these MTF values match, then authentication is considered successful.

To determine the MTF target patterns adapted to provide security authentication, one or more combinations of desired reading devices and desired printing devices are qualified (308). That is, a priori it is determined which reading devices, or reading device types, and which printing devices, or printing device types, will be used in combination with one another. The printing devices selected are those that will be employed to print the MTF target patterns on media, whereas the reading devices selected are those that will be employed to read the MTF target patterns printed on the media.

Each different printing device prints a large variety of different sequences of different MTF target patterns, where each sequence has a unique combination of high-frequency MTF target patterns and low-frequency MTF target patterns. For example, the sequences of MTF target patterns 402 of FIG. 4 may be printed by each different printing device that will ultimately be used to print MTF target patterns. The MTF target patterns have to be printed by each different printing device, or by an instance of each different type of printing device, because different printing devices or different types of printing devices may have different capabilities, and thus print the MTF target patterns differently. For example, a laser-printing device may be able to print higher-frequency MTF target patterns with better precision than an ink-ejection printing device can.

Thereafter, each different reading device reads the large variety of different sequences of different MTF target patterns printed by each different printing device. The MTF target patterns as printed by each different printing device are read by each different reading device, or by an instance of each different type of reading device, because different reading devices or by an instance of each different type of reading device, because different reading devices or different types of reading devices may have different capabilities. As such, they may read the MTF target patterns differently. For example, one type of optical scanning device may have a resolution of discernment of thirty LPI, whereas another may have a comparable resolution of sixty LPI.

The point of performing this qualification is to determine the minimum spacings between successive LPI values of MTF target patterns that can be printed by the printing device of any printing device-reading device pair and then read by the reading device of any pair. As a rudimentary and hypothetical example, a reading device may be able to discern MTF target patterns printed by a first printing device at seventy LPI at most, and may be able to discern between low-frequency MTF target patterns separated by ten LPI at most, and between high-frequency MTF target patterns separated by four LPI at most. The same reading device may be able to discern MTF target patterns printed by a second printing device at sixty LPI at best, and may be able to discern between low-frequency MTF target patterns separated by nine LPI at most, and between high-frequency MTF target patterns separated by five LPI at most.

If this is the only reading device, or reading device type, that will be used to read MTF target patterns, the minimum spacing for low-frequency MTF target patterns is nine LPI, taken from the reading device-second printing device pair. The minimum spacing for high-frequency MTF target patterns is four LPI, taken from the reading device-first printing device pair. The maximum frequency of any MTF pattern is specified as sixty LPI, also taken from the reading device-first printing device pair. Thus, these specifications provide that no matter which combination of printing device-reading device pair is used, proper MTF target pattern discern will occur.

Therefore, based on the qualification of the unique reading device-printing device combinations, authentication specifications are determined, or specified, for the MTF target patterns for authentication purposes (310). Besides the minimum spacing between adjacent LPI values for both high-frequency LPI values and low-frequency LPI values, a minimum LPI value and a maximum LPI value may be specified for both high-frequency and low-frequency LPI values. A minimum spacing between a given high-frequency LPI value and a given low-frequency LPI value may further be specified. At least some of these specifications may not be in actuality completely determined by the qualification performed in part 308, but instead arbitrarily selected by a user.

An example authentication specification for MTF target patterns may be provided in a markup language, such as the extensible Markup Language (XML), as follows:

```
<?XML version = “1.0”?>
<MTF>
    <LPI1 Start = “20” End = “70”/>
        <Step Start = “20” End = “70” Size = “1”/>
    <LPI2 Start = “75” End = “125”/>
        <Step Start = “75” End = “96” Size = “3”/>
        <Step Start = “96” End = “104” Size = “4”/>
        <Step Start = “104” End = “125” Size = “3”/>
    <MinSpacing>30</MinSpacing>
<MTF>
```

In this example, two different types of MTF target patterns are defined: those having an LPI, or frequency, selected from LPI1; and those having an LPI, or frequency, selected from LPI2. The former are low-frequency MTF target patterns, having a minimum frequency of 20 LPI, a maximum frequency of 70 LPI, and at step sizes (i.e., at minimum spacings therebetween) of one LPI. Therefore, the set of LPI values within LPI1 is: 20, 21, 22 . . . 68, 69, 70.

By comparison, the MTF target patterns defined within LPI2 are high-frequency MTF target patterns, having a minimum frequency of 75 LPI and a maximum frequency of 125 LPI. For frequencies between and encompassing 75 and 96 LPI, there is a step size (i.e., a minimum spacing therebetween) of three LPI, as there is for frequencies between and encompassing 104 and 125 LPI. For frequencies between and encompassing 96 and 104 LPI, there is a step size of four LPI. Therefore, the set of LPI values within LPI2 is 75, 78, 81, 84, 87, 93, 96, 100, 104, 107, 110, 113, 116, 119, 122, and 125.

Finally, the MinSpacing value specifies the minimum spacing between a low-frequency MTF target pattern having a frequency selected from LPI1 and a high-frequency MTF target pattern having a frequency selecting from LPI2, of 30 LPI. Thus, for instance, the high-frequency LPI of 75 cannot be paired with a low-frequency LPI above 45 LPI. In this example, then, there is a total of 751 distinct, differentially authenticable pairs of high- and low-frequency patterns that can be simultaneously employed for both quality assurance verification as well as for security authentication, corresponding to approximately nine-and-a-half bits of information. As such, two patterns can be employed to encode 19 bits of information, since 751 times 751 is greater than 2¹⁹.

Finally, based on the authentication specifications determined, a sequence of MTF target patterns for security authentication is determined (312). This authentication sequence of MTF target patterns may be coincident (i.e., integral) with, a subset of, or completely exclusive with the MTF target patterns previously determined to provide quality assurance verification in part 304. For example, in one embodiment, all of the MTF target patterns employed for quality assurance verification purposes are also for security authentication purposes. In such instance, then, the MTF target patterns are selected in part 302 so that all of them satisfy the quality assurance verification constraints of part 304 as well as the security authentication constraints of part 306.

As another example, however, the sequence of MTF target patterns selected for security authentication purposes in part 306 may represent just a subset of all the MTF target patterns selected for quality assurance purposes in part 304. FIG. 5, for instance, shows some of the MTF target patterns that have been selected, or determined, for use in quality assurance, according to an embodiment of the invention. These MTF target patterns include one or more high frequency-low frequency MTF target pattern pairs 502A, 502B, 502C, 502D, 502E, and 502F, collectively referred to as the high frequency-low frequency MTF target pattern pairs 502, where each of the pairs 502 can include one or more high-frequency MTF patterns and one or more low-frequency MTF patterns. For example, the pairs 502A may correspond to the sequence ot MTF target patterns 402A of FIG. 4, and thus include the high frequency-low frequency pair of MTF patterns 102A and 102C and the high frequency-low frequency pair of MTF patterns 102B and 102D.

Likewise, the MTF target patterns selected for quality assurance verification purposes include in FIG. 5 one or more high frequency-low frequency MTF target pattern pairs 504A, 504B, 504C, 504D, 504E, and 504F, collectively referred to as the high frequency-low frequency MTF target pattern pairs 504. The MTF target patterns selected for quality assurance verification purposes further include the high frequency-low frequency MTF target pattern pairs 506A, 506B, 506C, 506D, 506E, and 506F, collectively referred to as the high frequency-low frequency MTF target pattern pairs 504. Now, in one embodiment, all of the MTF target patterns selected for quality assurance verification purposes are also employed for security authentication purposes, and thus all of the MTF target pattern pairs 502, 504, and 506 are employed for both of these purposes.

However, in another embodiment, just some of the MTF target patterns selected for quality assurance verification purposes may be employed for security authentication purposes as well. The authentication sequence of the MTF target patterns employed for security authentication purposes may be determined as the pairs 502A, 502D, 502F, 502G, 504B, 504C, 504D, 504G, 506A, 506D, 506E, and 506F, as one arbitrary example. Thus, the selection of the sequence of MTF target patterns for security authentication may specify an arbitrary sequence of the MTF target patterns for quality assurance verification, where this sequence is then provided to legitimate users that will be verifying MTF target patterns for security authentication purposes.

As also noted above, in one embodiment, the MTF target patterns selected for quality assurance verification purposes may be mutually exclusive with those employed for security authentication purposes. As an example using the MTF target pattern pairs 502, 504, and 506 of FIG. 5, for instance, the MTF target pattern pairs 502 and 504 may be selected or determined for quality assurance verification purposes. The MTF target pattern pairs 506 may then be selected or determined for security authentication purposes.

Regardless of how the MTF target patterns for security authentication purposes are selected, each of the MTF target patterns in this authentication sequence of such patterns includes a specified authentication LPI value. It is noted that the authentication LPI values for the MTF target patterns of the authentication sequence (or the authentication MTF values for these LPI values) may be shared by the entity in question with trusted users who are to perform authentication. Alternatively, these authentication LPI (or MTF) values may be retained by just the entity itself, and not shared with any users. In the latter instance, authentication thus requires passing read LPI values (or MTF values determined based on these LPI values) to the entity.

The method 300 of FIG. 3 concludes by a printing device actually printing the MTF target patterns that have been determined in part 302 on a medium (314). It is noted, however, that to further frustrate potential counterfeiters, the MTF target patterns of the authentication sequence in particular may be printed with printed LPI values that differ from their specified authentication LPI values. For example, an authentication MTF target pattern may have a specified authentication LPI value of 60, with a step size of 10 to the next nearest LPI values of 50 and 70. The reading device used to read this MTF target pattern may have a resolution such that a printed LPI value of 60 may by read as anywhere from 58-62 LPI. Because it is known that allowable authentication LPI values occur at 50, 60, or 70, any reading from 58-62 LPI may be rounded to 60 LPI.

Therefore, it may be decided to print this authentication MTF target pattern with a specified printed LPI value that differs from the specified authentication LPI value. (Alternatively, an authentication MTF target pattern may be printed with a specified printed LPI value that is identical to, or the same as, the specified authentication LPI value.) That is, rather than printing this MTF target pattern at an LPI of 60, it may be printed at an LPI of 62. Having a specified printed LPI value of 62 means that the reading device may read this value as anywhere from 60-64 LPI. This is acceptable, because since it is known that allowable authentication LPI values occur at 50, 60, or 70, any reading from 60-64 LPI will still be rounded to 60 LPI.

However, a potential counterfeiter without the benefit of this knowledge may ultimately make an unauthorized copy of the MTF target pattern in question that fails authentication. For example, using the same reading device, the counterfeiter may read the specified printed LPI value for this MTF pattern as 64 LPI, even though the specified printed LPI value is 62 LPI, and even though the actually specified authentication LPI value is 60 LPI. The counterfeiter in printing a forgery of the MTF target pattern prints the forged MTF target pattern at 64 LPI.

However, when the reading device is used to read the forged MTF target pattern, any reading from 62-66 LPI may occur. While readings from 62-64 may result in rounding to 60 LPI, equal to the specified authentication LPI value, readings from 65-66 may result in rounding to 70 LPI, such that the forged MTF target pattern fails authentication. Where there is a sufficiently large number of MTF target patterns within the authentication sequence, the odds of such forgery miscopying at least one of the MTF patterns becomes relatively certain, such that in effect forgeries of the authentication sequence of MTF target patterns are highly unlikely to be made.

Printing of the security authentication MTF target patterns may be achieved in the same or different manner as the quality assurance MTF target patterns in part 314. For example, the quality assurance MTF target patterns may be printed with standard colorants that are discernable in visible light. Such standard colorants include readily available black ink, in the case of fluid-ejection printing devices, and readily available black toner, in the case of laser printing devices. The security authentication MTF target patterns, even those that are mutually exclusive with the quality assurance MTF target patterns, may thus also be printed with colorants discernible in visible light. As such, reading devices such as commonly available optical scanning devices may be used to read these MTF target patterns.

However, in another embodiment, the security authentication MTF target patterns may be printed with different types of colorants, which are specifically undiscernable in visible light. Such colorants include infrared (IR) and ultraviolet (UV) inks and toner, which when applied to media, are visible only under IR light and UV light, respectively. Printing at least some of the security authentication MTF target patterns in this manner—where other of the authentication MTF target patterns are printed in colorants discernible in visible light—provides an extra modicum of security. In particular, users have to have reading devices that are capable of reading MTF target patterns printed with IR or UV colorants, and furthermore have to know in the first place that MTF target patterns have been printed on a given medium with such colorants. A user cursorily inspecting a given medium under normal visible light conditions would not detect such MTF target patterns, for instance. In addition, patterns using two different types of colorant undiscernable in visible light, such as one printed using IR ink or toner and another printed UV ink or toner, may be achieved.

### Method for Reading MTF Patterns and Performing Quality Assurance and Authentication

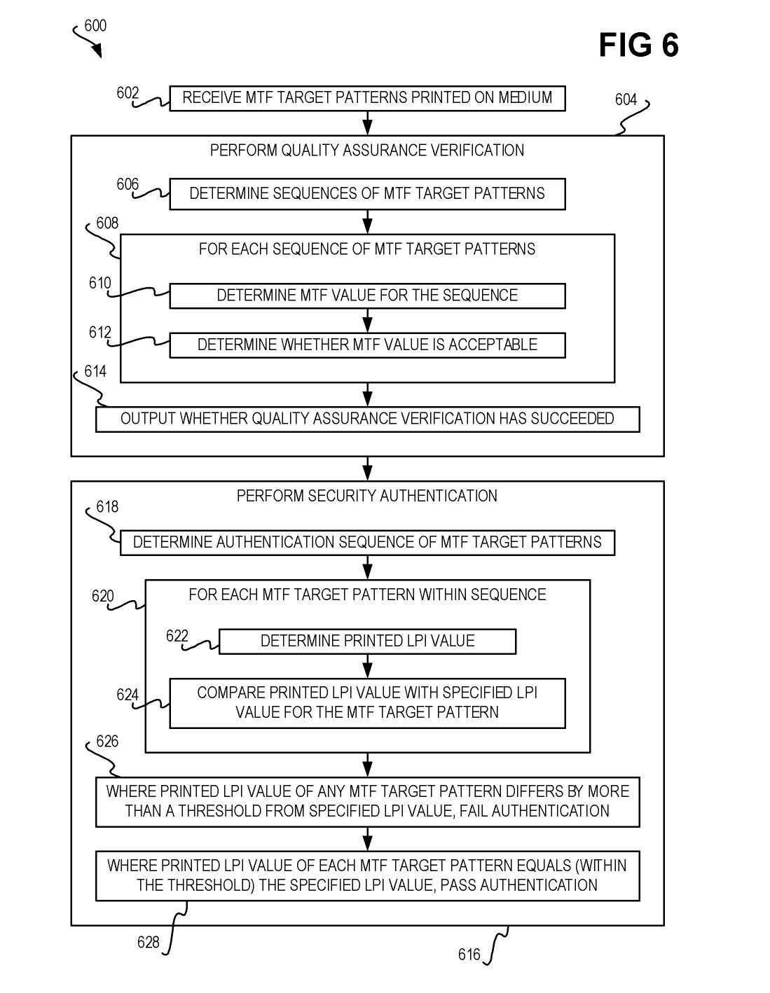

FIG. 6 shows a method 600 for reading MTF target patterns, as may have been printed by performing the method 300 of FIG. 3, and for then performing quality assurance verification and security authentication, according to an embodiment of the invention. The method 600 may be performed in one embodiment as one or more computer programs stored on a computer-readable medium, for execution on a computing device or another type of device having computing capability. The MTF target patterns printed on a medium are received (602).

For instance, a reading device, such as an optical scanning device, may detected and read the MTF target patterns, and this information submitted where appropriate to the mechanism or program performing the method 600. Reading the MTF target patterns can in at least some embodiments include reading a substantial portion of the medium on which they are printed, and identify the locations of the MTF target patterns. For example, directed segmentation, as known within the art, may be employed to assist in identifying where the MTF target patterns are located on the medium. Other types of approaches may also be employed to locate the MTF target patterns printed on the medium, as can be appreciated by those of ordinary skill within the art.

Quality assurance verification can be performed in relation to the MTF target patterns that have been read (604). In one embodiment, quality assurance verification is performed by performing parts 606, 608, 610, 612, and 614. Thus, a number of sequences of the MTF target patterns that have been read are identified (606). For instance, in relation to the MTF target patterns of FIG. 4 that have been described, the sequences of MTF target patterns 402 are determined by grouping all MTF target patterns within the same row as part of the same sequence. Thus, because the MTF target patterns 102 are located within the same row on the medium in question, they are grouped within the same sequence of MTF target patterns 402A.

Thereafter, the following is performed for each sequence of MTF target patterns (608). The MTF value for the sequence is determined (610), as has been described previously in the detailed description. Furthermore, when the MTF value of the MTF target patterns of a sequence is computed, if it is greater than one, then this means that the high-frequency MTF target patterns have erroneously been considered the low-frequency MTF target patterns, and vice-versa. Thus, the relative order of the MTF target patterns for a given type (horizontal or vertical), can be easily determined when calculating the MTF value during the quality assurance verification process.

Next, it is determined whether the MTF value for the sequence of MTF target patterns in question is acceptable or not (612). For instance, based on a predetermined specification, it may be known that for a given sequence of given MTF target patterns, a specified MTF value should result. If the MTF value for any sequence of MTF target patterns varies from the specified MTF value by more than a threshold, therefore, it may be concluded that the reading device failed quality assurance verification.

In one embodiment, whether the reading device has passed the quality assurance verification based on whether the MTF value for each sequence of MTF target patterns is acceptable is output (614). Such output may include logging the success or failure of the quality assurance verification. Such output may further include alerting the user where quality assurance verification has failed, such as by lighting an appropriate light on the reading device itself. Output may be performed in other ways as well.

Security authentication is also performed based on the MTF target patterns printed on the medium as has been read by the reading device (616). An authentication sequence of MTF target patterns within all of these MTF target patterns may be initially determined (618). As has been described, not all of the MTF target patterns printed on the medium may be for security authentication purposes. Determining the authentication sequence of MTF target patterns thus encompasses selecting which of the MTF target patterns should be used for security authentication. As one arbitrary example, it may be known a priori that of nine-hundred MTF target patterns, every tenth MTF pattern should be included as part of the authentication sequence. As such, the authentication sequence of the appropriate ninety MTF target patterns is assembled or identified.

In one embodiment, security authentication is then achieved by performing parts 620, 622, 624, 626, and 628 of the method 600. After description of these parts, another manner by which security authentication can be achieved is described. Therefore, first, for each MTF target pattern within the authentication sequence (620), the printed LPI value is determined (622). The printed LPI value is effectively inherently read as part of the reading device reading the MTF target pattern, in one embodiment.

In another embodiment, the printed LPI value may be determined in another manner. For example, a fast Fourier transform (FFT) operation may be performed on the data read for an MTF target pattern by the reading device, along a sample single-pixel or multiple-pixel “slice” of the MTF target pattern in a direction perpendicular to the lines of the MTF target pattern. The result of this operation may be an FFT coefficient that corresponds to the printed LPI value. A number of such sample slices may have their resulting FFT coefficients read and averaged to yield the printed LPI value. FFT and other operations may further be employed to assist in distinguishing between low-frequency MTF target patterns and high-frequency MTF target patterns, as can be appreciated by those of ordinary skill within the art. The approach employed to determine the printed LPI value of a low-frequency MTF target pattern may further be different or the same as that used to determine the printed LPI value of a high-frequency MTF target pattern.

The printed LPI value as read and/or determined is then compared against the specified LPI value for the MTF target pattern (624). As has been noted in the previous section of the detailed description, the printed LPI value can indeed be varied from the specified LPI value, even if the former is precisely and accurately read without any error, to frustrate potential counterfeiters. Where the printed LPI value of any MTF target pattern of the authentication sequence differs by more than a threshold from the specified LPI of the MTF target pattern, authentication fails (626).

For example, output may be provided as to the failure of authentication, to notify the user of this situation, or to otherwise log the failure. By comparison, where the printed LPI values of all the MTF target patterns of the authentication sequence equal the specified LPI values of these MTF target patterns, authentication succeeds (628). Output may further be provided as to the success of authentication, to notify the user of this situation, or to otherwise log the success.

The threshold may in one embodiment be different based on whether the MTF target pattern is a high-frequency MTF pattern or a low-frequency MTF pattern, and indeed may potentially even differ on an MTF target pattern-by-MTF target pattern basis. In particular, the threshold may be smaller for low-frequency MTF patterns than for high-frequency MTF patterns, because the LPI values for the latter patterns are typically more spread out and more difficult to read than those for the former patterns. Alternatively, the threshold may be the same or identical for all the MTF target patterns.

The specified LPI values may or may not be stored by the program or other mechanism performing at least part of the security authentication process of part 616 of the method 600. Where it does, the entity that is being authenticated by this process desirably ensures that the user of this program or other mechanism can be trusted with the specified LPI values. Alternatively, the printed LPI values as read by the reading device may be transmitted to the entity, which then compares them against the specified LPI values and determines whether security authentication has passed. For instance, in part 620, the printed LPI values may be transmitted to the entity, such that the entity performs parts 622 and 624.

As another alternative, the specified LPI values may be encoded within the medium itself, in a different manner than by using MTF target patterns. An image may be printed on the medium within which the specified LPI values are encoded, for instance. In this way, the specified LPI values may nevertheless be provided to the user of the program or other mechanism performing at least part of the security authentication process of part 616 of the method 600, without the user actually ever known the specified LPI values. As can be appreciated by those of ordinary skill within the art, other approaches for comparing the printed LPI values read by the reading device against the specified LPI values, and for storing the specified LPI values, may also be employed, without deviating from the overall scope of embodiments of the invention. Such example includes encrypted bar codes and digital watermarks, as can be appreciated by those of ordinary skill within the art.

The approach for security authentication outlined in parts 620, 622, 624, 626, and 628 of the method 600 utilizes a comparison of printed LPI values of individual MTF target patterns, as read by a reading device, against the specified authentication LPI values for these MTF target patterns. However, in another embodiment, security authentication may instead employ a comparison of MTF values calculated or otherwise determined based on the printed LPI values of MTF target pattern pairs or sequences, as read by a reading device, against specified authentication MTF values for these MFT target pattern pairs or sequences. If any of the calculated or otherwise determined MTF values fail to match their corresponding specified authentication MTF values (within a threshold in one embodiment), then authentication fails, and otherwise succeeds.

For example, in relation to the MTF target pattern sequences 402 of FIG. 4, two MTF values for each of the sequences may be determined, including a horizontal MTF value and a vertical MTF value. The horizontal and vertical MTF values for a given sequence of MTF target patterns may be compared against specified authentication horizontal and vertical MTF values for this sequence. In one embodiment, security authentication is said to succeed where both the horizontal and vertical MTF values for all the sequences match their corresponding specified authentication horizontal and vertical MTF values, within a given threshold, and otherwise is said to fail.

In another embodiment, however, security authentication is said to succeed where either the horizontal or the vertical MTF value for each sequence matches its corresponding authentication MTF value, within a given threshold. In this latter embodiment, a given MTF target pattern sequence is thus considered “matching” where either the horizontal MTF value thereof matches its corresponding specified authentication MTF value, the vertical MTF value thereof matches its corresponding authentication MTF value, or both these MTF values match their corresponding authentication MTF values. Finally, the approach employed to authenticate a low-frequency MTF target pattern may further be different or the same as that used to authenticate a high-frequency MTF target pattern.

### System and Advantages

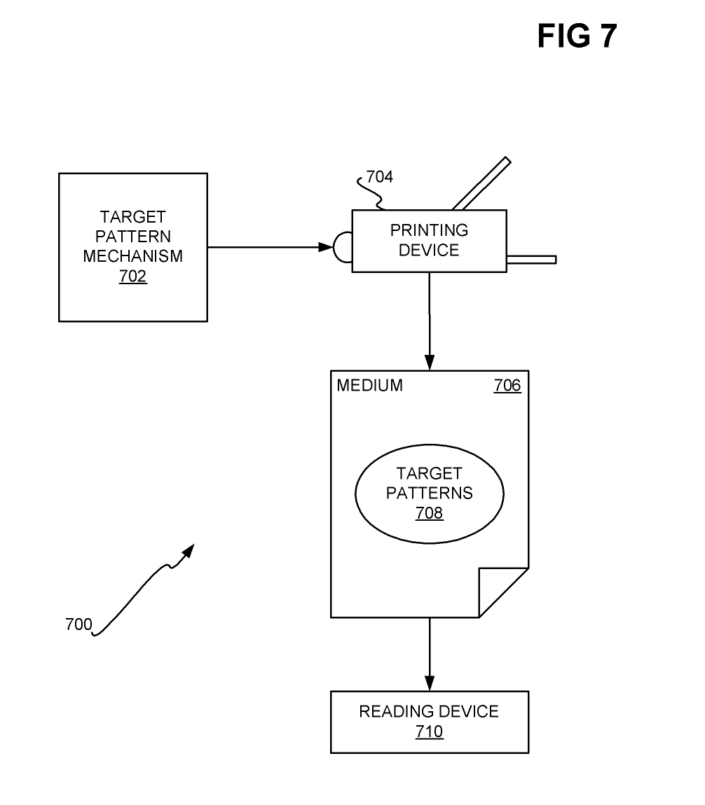

FIG. 7 shows a rudimentary system 700, according to an embodiment of the invention. The system 700 can include a target pattern mechanism 702 and a printing device 704. The system 700 may further include, in addition to or in lieu of the mechanism 702 and the device 704, a reading device 710. As can be appreciated by those of ordinary skill within the art, the system 700 may also include other components, in addition to and/or in lieu of those depicted in FIG. 7.

The target pattern mechanism 702 may be implemented in software, hardware, or a combination of software and hardware. The mechanism 702 can substantially perform the method 300 of FIG. 3, such that in part 314 thereof it directs the printing device 704 to print the modulation transfer function (MTF) MTF target patterns that have been determined. Thus, the mechanism 702 determines a number of quality assurance sequences of MTF target patterns, and/or an authentication sequence of MTF target patterns, as has been described.

The mechanism 702 may qualify one or more combinations of printing devices, such as the printing device 704, and reading devices, such as the reading device 710, as well, as has been described, as part of determining the authentication sequence of MTF target patterns. The mechanism 702 may additionally or alternatively determine or receive authentication specifications by which the authentication sequence of MTF target patterns is to be determined. The mechanism 702 may also direct the printing device 704 to print the MTF target patterns of the authentication sequence at specified authentication LPI values of the MTF patterns, or at specified printed LPI values that differ from the specified authentication LPI values, as has been described.

The printing device 704 may be a laser printing device, an ink-ejection printing device, or another type of printing device. The printing device 704 may be able to print using colorant discernible in visible light, or colorant discernible only in non-visible light, such as ultraviolet (UV) or infrared (IR) light. The printing device 704 prints MTF target patterns 708 onto a medium 706 as directed by the target pattern mechanism 702. The medium 706 may be paper, cardboard, plastic, or another type of medium, as can be appreciated by those of ordinary skill within the art.

The reading device 710 may be an optical scanning device, or another type of reading device. The reading device 710 at least detects or reads the MTF target patterns 708 printed on the medium 706. The reading device 710 in whole or in part may perform other aspects of the method 600 of FIG. 6 as well, to perform quality assurance verification and/or security authentication. Additionally or alternatively, another mechanism, such as a quality assurance and/or authentication mechanism (not depicted in FIG. 6) may in whole or in part perform the other aspects of the method 600, based on the MTF target patterns read by the reading device 710.

At least some embodiments of the invention provide for certain advantages. Existing scanning devices may be employed to achieve quality assurance verification and security verification. Because optical scanning devices in particular are readily available and inexpensive, this results in embodiments of the invention being relatively cost-effective to implement. Furthermore, as has been described, the MTF target patterns can be printed using colorant discernible in visible light, and/or using colorant that is not discernible in visible light. Stated another way, the security features provided by embodiments of the invention can be overt and/or covert. Other advantages are also provided by embodiments of the invention, as can be appreciated by those of ordinary skill within the art.

We claim:

1. A method comprising:
determining a plurality of modulation transfer function (MTF) target patterns capable of being printed on a medium, the MTF target patterns adapted to:
provide quality assurance (QA) verification of at least a reading device capable of reading the MTF target patterns printed on the medium; and,
provide security authentication of an entity associated with printing of the MTF target patterns on the medium; and,
printing the MTF target patterns on the medium.

2. The method of claim 1, wherein determining the MTF target patterns adapted to provide the QA verification comprises determining a plurality of sequences of MTF target patterns, each sequence of MTF target patterns comprising:
at least one first MTF target pattern having a first lines-per-inch (LPI) value; and,
at least one second MTF target pattern having a second LPI value greater than the first LPI value,
wherein an MTF value for the sequence of MTF target patterns is determinable based on the first LPI value of each first MTF target pattern and on the second LPI value of each second MTF target pattern.

3. The method of claim 1, wherein determining the MTF target patterns adapted to provide the security authentication comprises qualifying one or more combinations of reading devices and printing devices to determine one or more minimum spacings between successive lines-per-inch (LPI) values of the MTF target patterns.

4. The method of claim 1, wherein determining the MTF target patterns adapted to provide the security authentication comprises determining authentication specifications for the MTF target patterns comprising:
for each of a first set of lines-per-inch (LPI) values and a second set of LPI values greater than the LPI values of the first set:
a minimum LPI value, a maximum LPI value, and a spacing between adjacent LPI values.

5. The method of claim 1, wherein determining the MTF target patterns adapted to provide the security authentication comprises determining a sequence of MTF target patterns, each MTF target pattern having a specified authentication lines-per-inch (LPI) value.

6. The method of claim 5, wherein one or more of the MTF target patterns each has a specified printed LPI value that is identical to the specified authentication LPI value of the MTF target pattern.

7. The method of claim 5, wherein one or more of the MTF target patterns each has a specified printed LPI value that is different than the specified authentication LPI value of the MTF target pattern.

8. A computer-readable medium having a computer program stored thereon to perform a method comprising:
receiving, from a reading device, a plurality of modulation transfer function (MTF) target patterns printed on a printing medium and read by the reading device;
performing quality assurance (QA) verification of the reading device based on the MTF target patterns; and,
performing security authentication of an entity associated with printing of the MTF target patterns on the printing medium based on the MTF target patterns.

9. The computer-readable medium of claim 8, wherein receiving the MTF target patterns from the reading device comprises receiving information regarding the MTF target patterns printed on the printing medium as detected and read by the reading device.

10. The computer-readable medium of claim 8, wherein performing the QA verification of the reading device comprises:
determining a plurality of sequences of MTF target patterns within the MTF target patterns receiving from the reading device, each sequence of MTF target patterns comprising:
at least one first MTF target pattern having a first lines-per-inch (LPI) value; and,
at least one second MTF target pattern having a second LPI value greater than the first LPI value;
for each sequence of MTF target patterns,
determining an MTF value for the sequence of MTF target patterns based on the first LPI value of each first MTF target pattern and on the second LPI value of each second MTF target pattern;
determining whether the MTF value for the sequence of MTF target patterns is acceptable for the reading device based on a predetermined specification; and,
outputting whether the reading device has passed the QA verification based on whether the MTF value for each sequence of MTF target patterns is acceptable.

11. The computer-readable medium of claim 8, wherein performing the security authentication comprises:
determining a sequence of MTF target patterns within the MTF target patterns received from the reading device;
for each MTF target pattern within the sequence of MTF target patterns,
determining a printed lines-per-inch (LPI) value of the MTF target pattern;
comparing the printed LPI value of the MTF target pattern with a specified authentication LPI value for the MTF target pattern;
where the printed LPI value of any MTF target pattern differs by more than a threshold from the specified authentication LPI value for the MTF target pattern, failing the security authentication; and,
where the printed LPI value of each MTF target pattern equals within the threshold the specified authentication LPI value for the MTF target pattern, passing the security authentication.

12. The computer-readable medium of claim 11, wherein the threshold is identical for the specified authentication LPI value for each MTF target pattern.

13. The computer-readable medium of claim 11, wherein the threshold is different for a first set of the MTF target patterns within the sequence having first LPI values as compared to for a second set of the MTF target patterns within the sequence having second LPI values greater than the first LPI values.

14. A computerized system comprising:
a printing device capable of printing on a medium; and,
a target pattern mechanism to:
determine an authentication sequence of target patterns, each target pattern having a specified authentication lines-per-inch (LPI) value; and,
direct the printing device to print the authentication sequence of target patterns on the medium.

15. The computerized system of claim 14, wherein the target pattern mechanism is further to determine a plurality of quality assurance (QA) sequences of modulation transfer function (MTF) target patterns adapted to provide QA verification of at least a reading device capable of reading the MTF target patterns printed on the medium,
one or more of the target patterns of the authentication sequence being integrated within the QA sequences of MTF target patterns, each such target pattern of the authentication sequence being one of the MTF target patterns of the QA sequences.

16. The computerized system of claim 15, wherein the QA sequences of MTF target patterns are printed with colorant discernable in visible light.

17. The computerized system of claim 15, wherein one or more other of the target patterns of the authentication sequence are not integrated within the QA sequences of MTF target patterns, each such target pattern of the authentication sequence being printed with colorant undiscernable in visible light.

18. The computerized system of claim 14, wherein the target pattern mechanism is further to qualify one or more combinations of the printing device and reading devices capable of reading the target patterns printed on the medium, to determine one or more minimum spacings between successive LPI values of the target patterns.

19. The computerized system of claim 14, wherein the target pattern mechanism is further to receive authentication specifications for the authentication sequence of target patterns comprising:
for each of a first set of LPI values and a second set of LPI values greater than the LPI values for the first set:
a minimum LPI value, a maximum LPI value, and a spacing between adjacent LPI values.

20. The computerized system of claim 14, wherein for one or more of the target patterns, the target pattern mechanism is to direct the printing device to print the target pattern at specified printed LPI values identical to the specified authentication LPI values of the target patterns, and
wherein for one or more other of the target patterns, the target pattern mechanism is to direct the printing device to print the target pattern at specified printed LPI values different than the specified authentication LPI values of the target patterns.
